(19) United States
(12) Patent Application Publication
(10) Pub. No.: US 2025/0193715 A1
(43) Pub. Date: Jun. 12, 2025

(54) EARLY MONITORING INDICATION FOR A DOWNLINK CONTROL CHANNEL

(71) Applicant: Lenovo (United States) Inc., Morrisville, NC (US)

(72) Inventors: Karthikeyan Ganesan, Kronberg Im Taunus (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/054,182

(22) Filed: Feb. 14, 2025

(51) Int. Cl. H04W 24/08; H04L 5/00; H04W 52/02; H04W 72/0446; H04W 72/232

(52) U.S. Cl. CPC H04W 24/08; H04L 5/0053; H04W 52/0235; H04W 72/0446; H04W 72/232

(57) ABSTRACT

Various aspects of the present disclosure relate to an early monitoring indication for a downlink control channel. A user equipment (UE) may receive an early monitoring indication during a first resource in a time domain. The early monitoring indication indicates (e.g., configures) a second resource in the time domain and information associated with blind decoding of a downlink control channel. The information may include, but is not limited to, a codepoint or a bitmap that indicates a downlink control information (DCI) format to monitor, a search space identifier, a candidate level to monitor, or an aggregation level to monitor. The UE may monitor for the downlink control channel based on the second resource in the time domain and the information associated with the blind decoding of the downlink control channel.

### TECHNICAL FIELD

The present disclosure relates to wireless communications, and more specifically to monitoring for signaling.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive, during a first resource in a time domain, an early monitoring indication that indicates a second resource in the time domain and information associated with blind decoding of a downlink control channel, and monitor, based on the second resource in the time domain and the information associated with the blind decoding of the downlink control channel, for the downlink control channel.

A processor (e.g., a standalone processor chipset, or a component of a UE) for wireless communication is described. The processor may be configured to, capable of, or operable to perform one or more operations as described herein. For example, the processor may be configured to, capable of, or operable to receive, during a first resource in a time domain, an early monitoring indication that indicates a second resource in the time domain and information associated with blind decoding of a downlink control channel, and monitor, based on the second resource in the time domain and the information associated with the blind decoding of the downlink control channel, for the downlink control channel.

A method performed or performable by a UE for wireless communication is described. The method may include receiving, during a first resource in a time domain, an early monitoring indication that indicates a second resource in the time domain and information associated with blind decoding of a downlink control channel, and monitoring, based on the second resource in the time domain and the information associated with the blind decoding of the downlink control channel, for the downlink control channel.

In some implementations of the UE, the processor, and the method described herein, the UE, the processor, and the method may further be configured to, capable of, or operable to monitor for the early monitoring indication based on at least one of a codepoint or a bitmap using a sequence or one or more modulated symbols in one or more resources in the time domain including the first resource. In some implementations of the UE, the processor, and the method described herein, the early monitoring indication includes at least one of a search space to monitor, a search space identifier associated with one or more monitoring occasions, a codepoint associated with search space group switching, or a bitmap associated with the search space group switching. In some implementations of the UE, the processor, and the method described herein, the early monitoring indication includes at least one of a codepoint or a bitmap that indicates a set of consecutive resources in the time domain that include the downlink control channel, and where the set of consecutive resources includes the second resource. In some implementations of the UE, the processor, and the method described herein, the early monitoring indication includes at least one of a codepoint or a bitmap that indicates a set of non-consecutive resources in the time domain that include the downlink control channel, and where the UE, the processor, and the method may further be configured to, capable of, or operable to monitor, based on the set of non-consecutive resources in the time domain, for the downlink control channel.

In some implementations of the UE, the processor, and the method described herein, the early monitoring indication indicates at least one third resource in the time domain without the downlink control channel, and where the UE, the processor, and the method may further be configured to, capable of, or operable to refrain from monitoring for the downlink control channel during the at least one third resource. In some implementations of the UE, the processor, and the method described herein, the information includes at least one of a codepoint or a bitmap that indicates a downlink control information (DCI) format to monitor, a search space identifier, a candidate level to monitor, or an aggregation level to monitor for the blind decoding of the downlink control channel. In some implementations of the UE, the processor, and the method described herein, the UE includes a first radio and a second radio, and where to receive the early monitoring indication, the UE, the processor, and the method may further be configured to, capable of, or operable to receive, via the first radio, a wake-up signal (WUS) for activating the second radio that includes the early monitoring indication. In some implementations of the UE, the processor, and the method described herein, to receive the early monitoring indication, the UE, the processor, and the method may further be configured to, capable of, or operable to receive DCI including the early monitoring indication.

In some implementations of the UE, the processor, and the method described herein, the UE, the processor, and the method may further be configured to, capable of, or operable to receive signaling that indicates the first resource. In some implementations of the UE, the processor, and the method described herein, the early monitoring indication is associated with a group of UEs including the UE based on at least one of a sequence of the early monitoring indication or a modulated symbol of the early monitoring indication. In some implementations of the UE, the processor, and the method described herein, the early monitoring indication indicates at least one of a control resource set (CORESET) or a search space corresponding to the first resource, and where the second resource is based on the at least one of the CORESET or the search space. In some implementations of the UE, the processor, and the method described herein, the early monitoring indication is associated with an orthogonal Zandoff-Chu sequence generated using a cyclic shift, and where the orthogonal Zandoff-Chu sequence is spread based on one or more frequency resources associated with the early monitoring indication.

An NE (e.g., a base station) for wireless communication is described. The NE may be configured to, capable of, or operable to perform one or more operations as described herein. For example, the NE may be configured to, capable of, or operable to transmit, during a first resource in a time domain, an early monitoring indication that indicates a second resource in the time domain and information associated with blind decoding of a downlink control channel, and transmit, based on the second resource in the time domain and the information associated with the blind decoding of the downlink control channel, the downlink control channel.

A processor (e.g., a standalone processor chipset, or a component of a NE) for wireless communication is described. The processor may be configured to, capable of, or operable to perform one or more operations as described herein. For example, the processor may be configured to, capable of, or operable to transmit, during a first resource in a time domain, an early monitoring indication that indicates a second resource in the time domain and information associated with blind decoding of a downlink control channel, and transmit, based on the second resource in the time domain and the information associated with the blind decoding of the downlink control channel, the downlink control channel.

A method performed or performable by an NE (e.g., a base station) for wireless communication is described. The method may include transmitting, during a first resource in a time domain, an early monitoring indication that indicates a second resource in the time domain and information associated with blind decoding of a downlink control channel, and transmitting, based on the second resource in the time domain and the information associated with the blind decoding of the downlink control channel, the downlink control channel.

In some implementations of the NE, the processor, and the method described herein, the NE, the processor, and the method may further be configured to, capable of, or operable to transmit the early monitoring indication based on at least one of a codepoint or a bitmap using a sequence or one or more modulated symbols in one or more resources in the time domain including the first resource. In some implementations of the NE, the processor, and the method described herein, the early monitoring indication includes at least one of a search space to monitor, a search space identifier associated with one or more monitoring occasions, a codepoint associated with search space group switching, or a bitmap associated with the search space group switching. In some implementations of the NE, the processor, and the method described herein, the early monitoring indication includes at least one of a codepoint or a bitmap that indicates a set of consecutive resources in the time domain that include the downlink control channel, and where the set of consecutive resources includes the second resource. In some implementations of the NE, the processor, and the method described herein, the early monitoring indication includes at least one of a codepoint or a bitmap that indicates a set of non-consecutive resources in the time domain that include the downlink control channel, and where the NE, the processor, and the method may further be configured to, capable of, or operable to transmit, based on the set of non-consecutive resources in the time domain, the downlink control channel.

In some implementations of the NE, the processor, and the method described herein, the early monitoring indication indicates at least one third resource in the time domain without the downlink control channel, and where the NE, the processor, and the method may further be configured to, capable of, or operable to refrain from transmitting the downlink control channel during the at least one third resource. In some implementations of the NE, the processor, and the method described herein, the information includes at least one of a codepoint or a bitmap that indicates a DCI format for a UE to monitor, a search space identifier, a candidate level for the UE to monitor, or an aggregation level for the UE to monitor for the blind decoding of the downlink control channel. In some implementations of the NE, the processor, and the method described herein, to transmit the early monitoring indication, the NE, the processor, and the method may further be configured to, capable of, or operable to transmit, to a first radio associated with a UE, a WUS for activating a second radio associated with the UE, and where the WUS includes the early monitoring indication. In some implementations of the NE, the processor, and the method described herein, to transmit the early monitoring indication, the NE, the processor, and the method may further be configured to, capable of, or operable to transmit DCI including the early monitoring indication.

In some implementations of the NE, the processor, and the method described herein, the NE, the processor, and the method may further be configured to, capable of, or operable to transmit signaling that indicates the first resource. In some implementations of the NE, the processor, and the method described herein, the early monitoring indication is associated with a group of UEs based on at least one of a sequence of the early monitoring indication or a modulated symbol of the early monitoring indication. In some implementations of the NE, the processor, and the method described herein, the early monitoring indication indicates at least one of a CORESET or a search space corresponding to the first resource, and where the second resource is based on the at least one of the CORESET or the search space. In some implementations of the NE, the processor, and the method described herein, the early monitoring indication is associated with an orthogonal Zandoff-Chu sequence generated using a cyclic shift, and where the orthogonal Zandoff-Chu sequence is spread based on one or more frequency resources associated with the early monitoring indication.

### BRIEF DESCRIPTION OF THE DRAWINGS

FIGS. 1 through 3 illustrate examples of wireless communications systems in accordance with aspects of the present disclosure.

FIGS. 4 through 6 illustrate example waveform diagrams, in accordance with aspects of the present disclosure.

FIGS. 7 through 9 illustrates example transmission diagrams, in accordance with aspects of the present disclosure.

FIG. 10 illustrates an example waveform diagram, in accordance with aspects of the present disclosure.

FIG. 11 illustrates an example signaling diagram, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a UE in accordance with aspects of the present disclosure.

FIG. 16 illustrates a flowchart of a method performed by an NE in accordance with aspects of the present disclosure.

### DETAILED DESCRIPTION

A wireless communications system may include one or more devices, such as UEs and NEs, that transmit and receive signaling. In some cases, a NE may transmit signaling to a UE indicating a periodicity during which a downlink control channel transmission may arrive, referred to as monitoring occasions. The UE may monitor for the downlink control channel transmission according to the periodicity. For example, the UE may monitor for the downlink control channel transmission in each slot, where a slot is a communication resource unit in the time domain. However, the NE may not transmit the downlink control channel transmission in each slot, leading to inefficient use of computational resources at the UE due to the UE monitoring for the downlink control channel transmission. Additionally, or alternatively, the UE may perform blind decoding of a downlink control channel transmission, where the UE monitors for the downlink control channel transmission without receiving configuration information for the downlink control channel transmission (e.g., resource to monitor or a format of the downlink control channel transmission). A UE performing blind decoding of downlink control channel transmissions may lead to inefficient use of computational resources (e.g., memory, processing, power consumption) at the UE due to the UE attempting to decode multiple downlink control channel transmissions to receive relevant control information.

As described herein, to reduce power consumption related to periodically monitoring for downlink control channel transmissions or related to blind decoding of a downlink control channel transmission at a UE, a NE may transmit an early monitoring indication to the UE. For example, the NE may transmit DCI and/or a WUS to the UE that includes the early monitoring indication. The early monitoring indication may dynamically indicate one or more resources in the time domain that the UE is to monitor for a downlink control channel transmission. Additionally, or alternatively, the early monitoring indication may dynamically indicate information to reduce blind decoding for a downlink control channel. The information may include, but is not limited to, a DCI format to monitor, a search space identifier, a candidate level to monitor, or an aggregation level to monitor for the blind decoding of the downlink control channel. The UE may monitor for the downlink control channel transmission during the indicated resources in the time domain and/or using the information, such as using the indicated DCI format, the search space indicated by the search space identifier, the candidate level, or the aggregation level. In some examples, the UE may receive and decode the downlink control channel transmission.

By performing the described techniques, a UE in a wireless communications system can efficiently monitor for downlink control channel transmissions according to resources and/or information received in an early monitoring indication, rather than continuously monitoring for the downlink control channel transmission according to a periodicity or performing blind decoding. The NE transmitting an early monitoring indication to a UE reduces the use of computational resources at the UE, including memory, processing, and power consumption resources. Further, the NE transmitting the early monitoring indication to the UE reduces latency related to detecting and decoding control information (e.g., a DCI in the downlink control channel transmission), as the UE monitors defined resources and formats indicated by the early monitoring indication.

Reference is made herein to communicating data or information, such as signaling communication resources and/or control channel communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

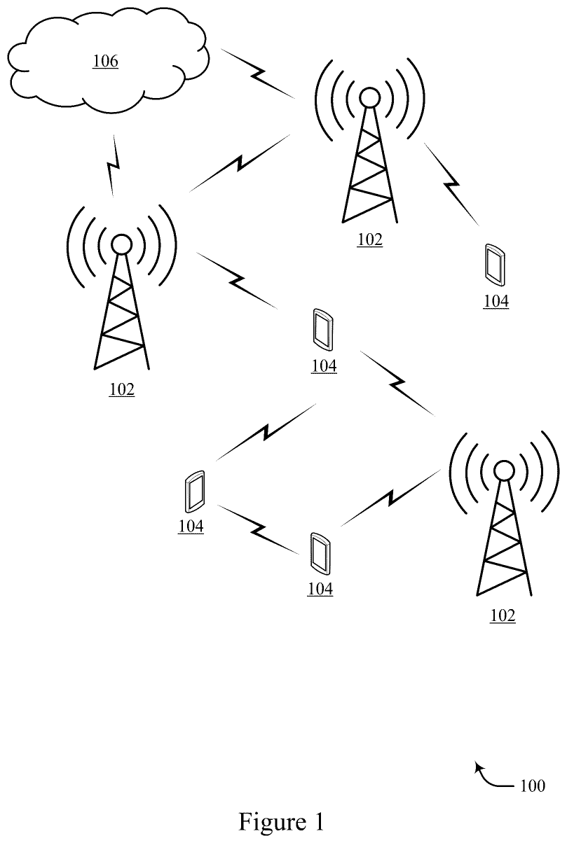

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologics (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologics). For example, FR2 may be associated with a third numerology (e.g., μ=2), which includes 60 kHz subcarrier spacing; and a fourth numerology (e.g., μ=3), which includes 120 kHz subcarrier spacing.

In some cases, a cell may refer to a radio access node in communication with a base station or including a base station. A cell may have a coverage area, which is a geographic area in which the cell may provide wireless connectivity to devices within. Different cells may operate on defined frequencies or frequency bands, referred to as subcarriers. In some examples, a UE 104 may establish a wireless connection with a cell, and subsequently that cell may be referred to as a serving cell of the UE 104.

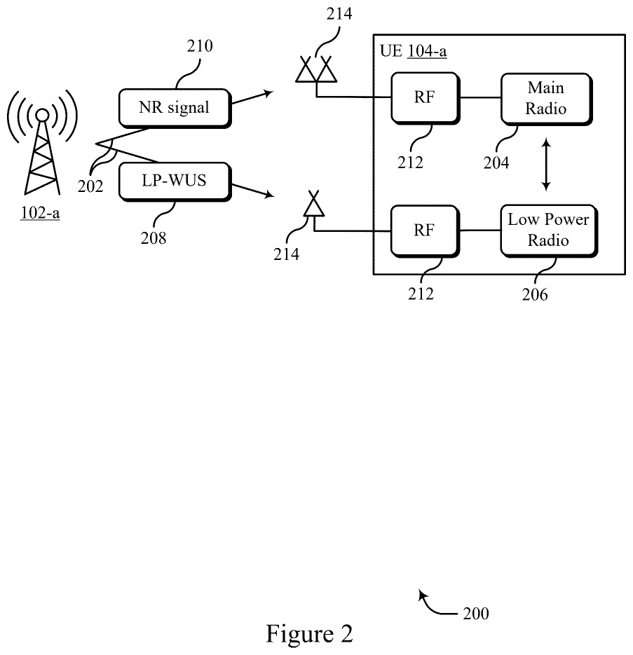

In some examples, the wireless communications system 100 may include one or more low power wireless devices. A low power wireless device may be a wireless device with reduced processing, power, and/or memory capabilities compared to other wireless devices. For example, a low power wireless device may be designed to operate with relatively low power consumption, with reduced transmission and/or reception capabilities (due to reduced transmit power, energy efficient radio transceivers, low power processors, etc.), or both. The low power device may perform energy harvesting techniques to collect and store energy from a received signal to supplement battery power, may utilize sleep modes for different components (transmitter, receiver, processing components etc.) of the wireless device, or the like. Examples of low power wireless devices include, but are not limited to, power sensitive and/or small form factor devices, such as IoT devices, industrial sensors, controllers, wearable device extended reality (XR) devices (e.g., smart glasses), and mobile devices. In some examples, the low power wireless device may be an example of a UE 104 with multiple radios, including a main radio and a low power radio, which is described in further detail with respect to FIG. 2.

In some examples, a NE 102 may transmit singling to a UE 104 that includes an early monitoring indication. The early monitoring indication may indicate one or more resources (e.g., slots in a time domain) and/or additional information related to when a UE 104 is to monitor for a downlink control channel transmission (e.g., a physical downlink control channel (PDCCH)). For example, the additional information may include a DCI format to monitor for, a search space to monitor, or an aggregate or candidate level to monitor, among other examples. The UE 104 may monitor for the downlink control channel transmission dynamically according to the early monitoring indication, which may reduce power consumption at the UE 104 when compared with periodically monitoring for the downlink control channel transmission or performing blind decoding to receive the downlink control channel transmission.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a wireless communications system 200, in accordance with aspects of the present disclosure. In some examples, the wireless communications system 200 implements aspects of the wireless communications system 100. For example, the wireless communications system 200 includes a NE 102-a and a UE 104-a, which may be examples of a NE 102 and a UE 104 as described with reference to FIG. 1. The NE 102-a may be an example of a base station and/or a serving cell. The NE 102-a may transmit signaling to one or more radios of the UE 104-a via a downlink wireless communications links 202. For example, the NE 102-a may transmit data, control signaling, or both to the UE 104-a via the downlink wireless communications links 202. Although the downlink wireless communications links 202 are illustrated as separate wireless communications links, the NE 102-a may establish a single downlink wireless communications link 202 with the UE 104-a.

In some cases, a UE 104-a may include multiple radio components for transmitting and receiving signaling from a network device, such as the NE 102-a. For example, the UE 104-a may include a main radio 204 and a low power radio 206. The main radio 204 may additionally, or alternatively, be referred to as or may implement a main receiver. Similarly, the low power radio 206 may additionally, or alternatively, be referred to as or may implement a low power receiver and/or a low power wake-up radio (LP-WUR). The main radio 204 may monitor for and receive communications using a higher power relative to communications sent to the low power radio 206. For example, the low power radio 206 may receive a low power WUS (LP-WUS) 208 and may subsequently wake-up the main radio 204 (e.g., by triggering or otherwise initiating an active mode at the low power radio 206). After waking up, the main radio 204 may receive an NR signal 210. The low power radio 206 may operate with reduced power consumption and/or reduced processing relative to the main radio 204. Thus, the low power radio 206 monitoring for a WUS may utilize relatively less power resources and/or processing resource relative to a main radio 204 monitoring for the WUS, providing for reduced power consumption at the UE 104-a. A UE 104-a may include any numerical quantity of radios (e.g., main radios 204 and low power radios 206).

In some examples, a low power radio 206 may have a separate baseband (BB) processor, radio frequency (RF) chain 212, and/or antenna 214 than the main radio 204. In some other examples, the low power radio 206 may have a separate BB processor but a shared RF chain 212 and a shared antenna 214 with the main radio 204. In yet other examples, the low power radio 206 may have a shared BB processor, RF chain 212, and antenna 214 with the main radio 204. For dynamic spectrum sharing (DSS), a single low power processor may be connected to the main radio 204 and one or more low power radios 206. A low power radio 206 may correspond to a radio access technology (RAT) or a frequency.

One or more receiver components of the UE 104-a (e.g., a receiver utilized by the main radio 204 and/or the low power radio 206) may have different components and/or functionality. For example, the low power radio 206 may include a heterodyne envelope detector implemented at an intermediate frequency (IF) level. Envelop detection is a demodulation process that extracts a shape that represents the varying amplitude of a modulated signal over time. A heterodyne envelope detector combines an incoming modulated signal with a local oscillator signal to obtain an IF. The IF represents a difference of the frequency of the modulated signal and the frequency of the local oscillator signal. The envelope detector extracts the envelope of the IF signal. In some other examples, the low power radio 206 may include a homodyne, or zero IF, envelop detector at the BB processor. In yet other examples, the low power radio 206 may include an OFDM-based sequence or signal with time domain and/or frequency domain correlation.

In some examples, the NE 102-a may select a waveform to utilize for generating the transmissions to the low power radio 206. For example, the NE 102-a may select a waveform that provides for a flat spectrum in the frequency domain, resulting in robustness against frequency selective fading compared to concentrated energy transmissions in the frequency domain. To achieve a flat spectrum transmission, the NE 102-a may select an amplitude-shift keying (ASK) modulation scheme, such as an OOK modulation scheme, or sequence. An ASK modulation scheme is a modulation scheme where a transmitting device (e.g., the NE 102-a) varies an amplitude of a signal between different levels to represent digital data. Different modulation schemes may include different numerical quantities of levels. For example, if there are two levels, then the data may be transmitted as binary values (e.g., “0” for a first amplitude level or “1” for a second amplitude level). For example, OOK-4 may refer to an OOK modulation scheme with four levels. An OOK-4 modulation scheme with a sequence (e.g., Zadoff-Chu, M-sequence, or quadrature amplitude modulation (QAM) sequence) applied before a Discrete Fourier Transform (DFT) and/or least square (LS) with variation in phase may achieve a flatter spectrum. In some examples, the UE 104-a knowing a sequence the NE 102-a used to generate a signal (e.g., a LP-WUS 208) may improve performance for a receiver of the UE 104-a.

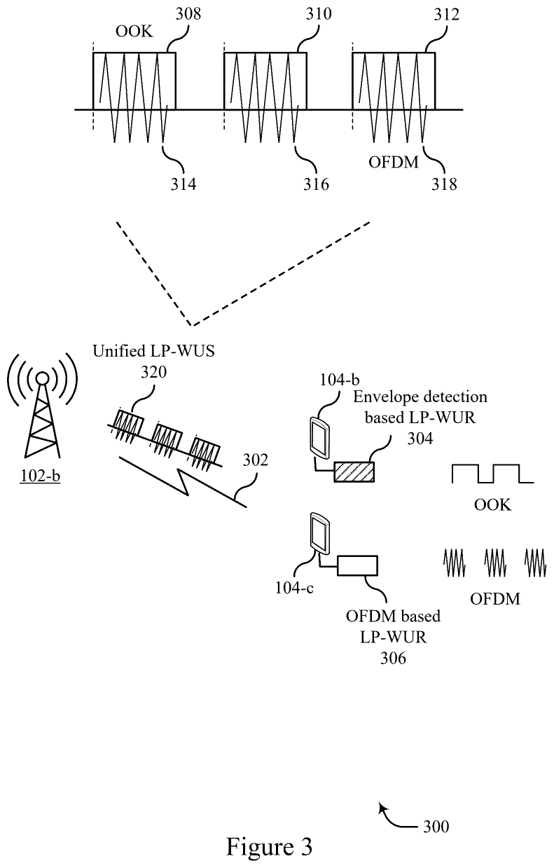

In some examples, a receiver may implement in-phase and quadrature (I/Q) branches to represent and demodulate a signal. For example, a receiver may separate a received signal into separate in-phase and quadrature components to represent the modulation of a signal. Knowledge of one or more sequences used in LP-WUS waveform generation may improve performance for at least a receiver with I/Q branches. In some examples, the NE 102-a may select a waveform with a harmonized design that accommodates different waveforms (e.g., OOK with one level (OOK-1), OOK-4, and an OFDM waveform). For example, the waveform may include OFDM sequences overlaid with OOK symbols, which is described in further detail with respect to FIG. 3. According to the harmonized waveform implementation, the OOK signal may include a sequence or randomly modulated symbols (e.g., for quadrature PSK (QPSK)) transmitted within an ON-duration of the OOK transmission to produce a flattened spectrum to improve against frequency selective fading. The sequence may be a Zadoff-Chu sequence, an M-sequence, a gold sequence, and/or a Golay sequence. In some cases, in the off duration of OOK transmission, no signal transmission occurs. A UE 104-a in a radio resource control (RRC) IDLE or INACTIVE state may support a low power-synchronization signal (LP-SS) in addition to a primary synchronization signal (PSS) and/or a secondary synchronization signal (SSS) (e.g., OOK-1 and/or OOK-4 waveform with or without overlayed OFDM sequences). In some examples, a receiver based on an envelope detector receiving the OOK waveform improves (e.g., maximizes) a power saving gain compared to an I/Q correlator receiver type. However, a coverage of receiver based on envelope detector is reduced relative to a coverage of the I/Q correlator receiver type.

FIG. 3 illustrates an example of a wireless communications system 300, in accordance with aspects of the present disclosure. In some examples, the wireless communications system 300 implements aspects of the wireless communications system 100 and the wireless communications system 200. For example, the wireless communications system 300 includes a NE 102-b, a UE 104-b, and a UE 104-c, which may be examples of a NE 102 and UEs 104 as described with reference to FIGS. 1 and 2. The NE 102-b may be an example of a base station and/or a serving cell. The NE 102-b may transmit signaling to one or more radios of a UE 104-b and/or a UE 104-c via one or more downlink wireless communications links 302. For example, the NE 102-b may transmit data, control signaling, or both to the UE 104-b and/or the UE 104-c via a downlink wireless communications link 302. Although the downlink wireless communications link 302 is illustrated as a single wireless communications link, the NE 102-b may establish multiple downlink wireless communications links 302 with the UE 104-b and/or the UE 104-c.

In some cases, the UE 104-b and the UE 104-c have different types of receivers. For example, the UE 104-b may have an envelope detection based LP-WUR 304 for receiving signaling sent using an OOK waveform. In some other examples, the UE 104-c may have an OFDM based LP-WUR receiver 306 for receiving signaling sent using an OFDM waveform. The NE 102-b transmits signaling using a waveform that is an overlaid sequence, using OOK and an OFDM sequence during an on duration of an OOK transmission. For example, during an on duration 308, an on duration 310, and an on duration 312 of an OOK transmission, the NE 102-b transmits an OFDM sequence 314, an OFDM sequence 316, and an OFDM sequence 318, respectively. The signaling that the NE 102-b transmits using OOK and the OFDM sequence may include a unified LP-WUS 320.

In an RRC IDLE state, a UE (e.g., the UE 104-b or the UE 104-c) may receive a WUS and perform a serving cell measurement. In an RRC CONNECTED state, a UE (e.g., the UE 104-bor the UE 104-c) may receive a LP-WUS. For example, the UE 104-b and/or the UE 104-c may receive the unified LP-WUS 320 instead of DCI (e.g., DCI 2_6). The unified LP-WUS 320 may wake-up a main radio of the UE 104-b and/or the UE 104-c for a connected mode discontinuous reception (C_DRX) active duration and a dynamic active timer configuration.

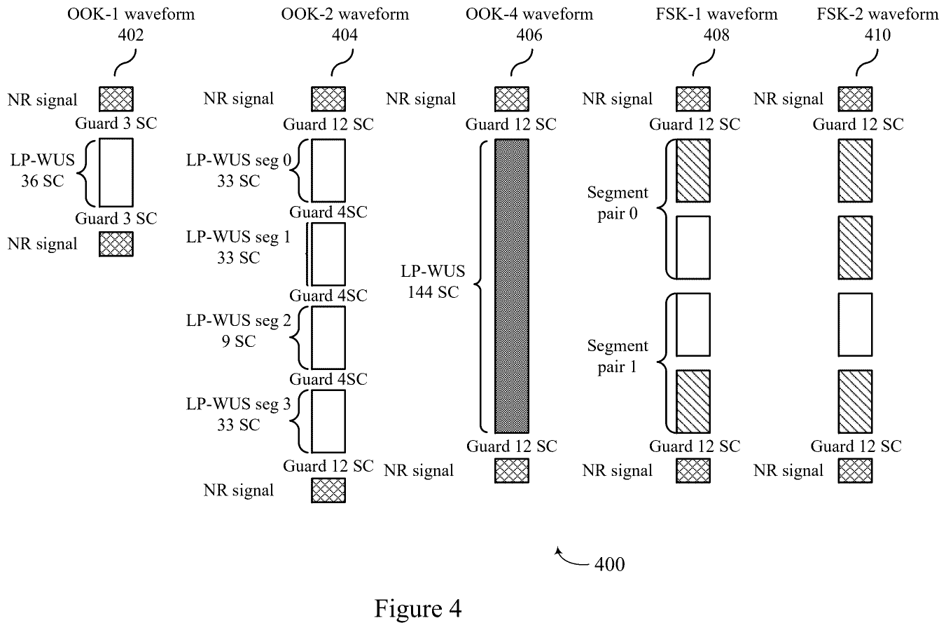

FIG. 4 illustrates an example of a waveform diagram 400, in accordance with aspects of the present disclosure. In some examples, the waveform diagram 400 implements aspects of the wireless communications system 100, the wireless communications system 200, and the wireless communications system 300. The waveform diagram 400 may be implemented by a NE and a UE, which may be examples of a NE 102 and a UE 104 as described with reference to FIGS. 1 through 3. For example, a NE and/or a UE may implement an OOK-1 waveform 402, an OOK-2 waveform 404, an OOK-4 waveform 406, a frequency-shift keying (FSK)-1 waveform 408, and/or an FSK-2 waveform 410.

An OOK waveform may include a numerical quantity of bits, M. A NE and/or a UE may determine the value of M for an OOK waveform with one or more overlaid sequences (e.g., used to transmit a LP-WUS in a time and a frequency domain). For example, for an OOK-1 waveform 402 and an OOK-4 waveform 406, M may have a value of one. In some cases, such as for an OOK-4 waveform 406 with M having a value of one, the one or more overlaid sequences may include the one or more sequences of an OOK on a symbol before a DFT or least square processing. A NE and/or a UE may apply a Zandoff-Chu sequence in a time domain, may apply the DFT or the least square processing, and then may apply an inverse Fast Fourier Transform (iFFT) to obtain a frequency domain sequence that is a Zandoff-Chu sequence or a sequence that is relatively similar to a Zandoff-Chu sequence (e.g., within a threshold similarity). In some other examples, M may be greater than one, and the NE and/or the UE may perform additional operations for an OOK-4 waveform. A size of the DFT can be 2ⁿ , where n is an integer value. In some cases, an OOK-1 waveform 402 may be an example of an OOK-4 waveform 406 with M having a value of one.

In some examples, the OOK-1 waveform 402 includes one or more bits allocated for an NR signal, as well as one or more bits allocated for a LP-WUS. The LP-WUS may be separated from the NR signal by a guard (e.g., guard band) of one or more subcarriers (SCs). For example, the LP-WUS may span 36 subcarriers, and may be separated from NR signaling by a 3 SC guard. In some examples, the OOK-2 waveform 404 includes one or more bits allocated for an NR signal, as well as one or more bits allocated for a LP-WUS. The LP-WUS may be segmented into four segments (e.g., LP-WUS seg 0, LP-WUS seg 1, LP-WUS seg 2, and LP-WUS seg 3) and the segments may be separated from one another and from the NR signal by a guard of one or more SCs. For example, the LP-WUS segments may each span 33 subcarriers, and may be separated from one another by a 4 SC guard and from the NR signaling by a 12 SC guard. In some examples, the OOK-4 waveform 406 includes one or more bits allocated for an NR signal, as well as one or more bits allocated for a LP-WUS. The LP-WUS may be separated from one another and from the NR signal by a guard of one or more SCs. For example, the LP-WUS may span 144 subcarriers and may be separated from the NR signaling by a 12 SC guard.

In some examples, the FSK-1 waveform 408 and FSK-2 waveform 410 may include one or more bits allocated for an NR signal, as well as one or more bits allocated for a LP-WUS or other signaling. The bits allocated for the LP-WUS and/or other signaling may be divided into segment pairs (e.g., a segment pair 0 and a segment pair 1). The segment pairs may be separated from one another and from the NR signal by guards of one or more SCs. For example, in the FSK-1 waveform 408, the LP-WUS may be split into two segment pairs, each spanning a different number of subcarriers, with a 12 SC guard separating the segment pairs from the NR signaling. The FSK-2 waveform 410 may have a similar structure but with additional segments between the guard, providing for different signaling patterns. In some cases, FSK is a modulation scheme in which signaling is transmitted through discrete frequency changes of a carrier signal. FSK waveforms may use different frequencies to represent different bit values, providing for more data to be transmitted in a given time period compared to OOK. OOK uses the presence or absence of a carrier wave to represent binary data, while FSK uses shifts between two or more frequencies.

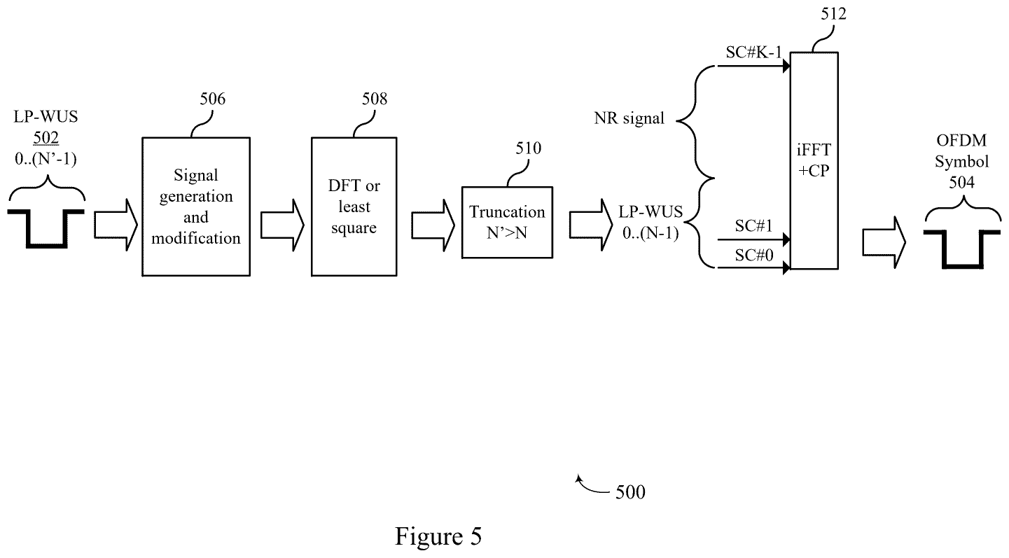

FIG. 5 illustrates an example of a waveform diagram 500, in accordance with aspects of the present disclosure. In some examples, the waveform diagram 500 implements aspects of the wireless communications system 100, the wireless communications system 200, the wireless communications system 300, and the waveform diagram 400. The waveform diagram 500 may be implemented by a NE and a UE, which may be examples of a NE 102 and a UE 104 as described with reference to FIGS. 1 through 3. For example, a NE and/or a UE may convert an input (e.g., a LP-WUS 502) into an OFDM symbol 504.

At 506, a NE and/or a UE may perform signal generation and may optionally modify the generated signal. For example, the NE and/or the UE may generate a base sequence, which may be derived from a predefined set of codes or generated dynamically based on system parameters. The NE and/or the UE may modify the base sequence by performing cyclic shifting, where the sequence elements are rotated by a specific number of positions, or by performing element-wise multiplication with a spreading code.

In some cases, at 508, the generated sequence may be further processed using DFT spreading, which may involve applying a DFT operation to spread the signal energy across a wider frequency range. Additionally, or alternatively, the NE and/or the UE may apply least square estimation, such as by using estimated channel information to equalize a received signal. For transformation of an M-bit OOK waveform in a time domain, a NE and/or a UE may generate N SCs of an OOK-1 waveform by a transformation (e.g., DFT or least square). The NE and/or the UE may generate N′ samples from M-bits, where there are M OOK bits per OFDM symbol. The NE and/or the UE may optionally use signal modification (e.g., shaping).

At 510, the NE and/or the UE may optionally truncate the generated samples, N′, and/or may use other additional modifications. If the NE and/or the UE does not truncate the samples, then a numerical quantity of bits to be mapped to SCs for transmission, N, is the same as a numerical quantity of bits in N′. Additionally, or alternatively, N′ can have a same value as a numerical quantity of SCs, K. At 512, the resulting spread sequence may be mapped to subcarriers for transmission using an iFFT and cyclic prefix.

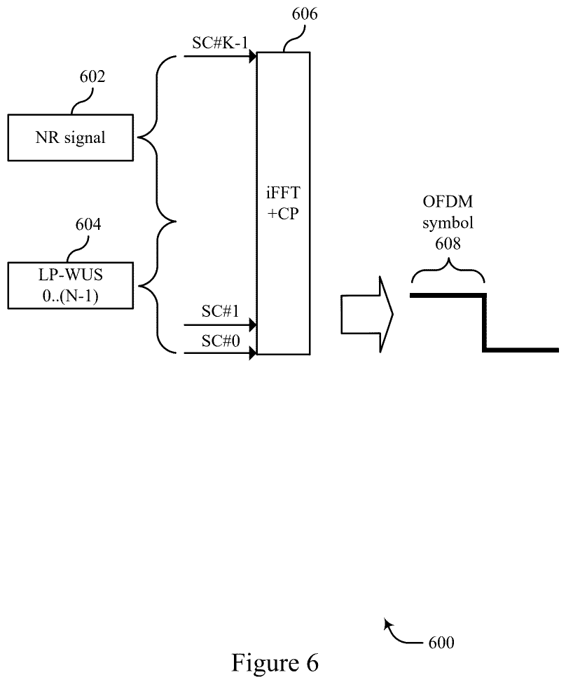

FIG. 6 illustrates an example of a waveform diagram 600, in accordance with aspects of the present disclosure. In some examples, the waveform diagram 600 implements aspects of the wireless communications system 100, the wireless communications system 200, the wireless communications system 300, the waveform diagram 400, and the waveform diagram 500. The waveform diagram 600 may be implemented by a NE and a UE, which may be examples of a NE 102 and a UE 104 as described with reference to FIGS. 1 through 3. For example, a NE and/or a UE may input signaling (e.g., an NR signal 602 and/or a LP-WUS 604) into an iFFT 606 to obtain an OFDM symbol 608.

In some examples, the NE and/or the UE may implement multi-carrier amplitude shift keying (MC-ASK) waveform generation by modulating multiple carrier frequencies with different amplitude levels to transmit signaling. The NE and/or the UE may use a MC-ASK waveform in addition to, or as an alternative to, an OOK waveform and an FSK waveform for transmitting the NR signal 602 and the LP-WUS 604. For example, an MC-ASK waveform may utilize multiple SCs within a given bandwidth, with each SC modulated using different amplitude levels to represent different symbols or bit patterns. The NE and/or the UE may map input bits to corresponding amplitude levels for each SC. Then, the NE and/or the UE may apply an iFFT to convert the frequency-domain representation of the NR signal 602 and the LP-WUS 604 to a time-domain signal. For a MC-ASK waveform, where K is the size of the iFFT 606 of cyclic prefix orthogonal frequency division multiple access (CP-OFDMA), N is a number of SCs used by a LP-WUS 604 including potential guard-bands. In some examples, the NE and/or the UE may implement an OOK-1 waveform in which an OFDM symbol 608 includes a single bit. In some examples, if OOK has a value of one, then all SCs are modulated. In some other examples, if OOK has a value of zero, then all SCs are zero power (e.g., from a base-band point of view).

The NE and/or the UE may implement one or more different options for overlaid OFDM sequences of a LP-WUS 604. For example, a single overlaid sequence is on each OOK ‘ON’ symbol or OFDM symbol duration. An OFDM-based LP-WUR can obtain all of the information bits by the presence of the overlaid sequence. Additionally, or alternatively, the overlaid OFDM sequence is pre-determined (e.g., defined) from a set of sequences. The sequence carries no information bits of a LP-WUS 604. An OFDM-based LP-WUR can obtain all of the information bits by an OOK ON/OFF pattern.

In some other examples, a NE and/or a UE may select a sequence from a set of candidate overlaid OFDM sequences on each OOK ‘ON’ symbol or OFDM symbol duration. An OFDM-based LP-WUR may obtain information bits of an LP-WUS 604 at least by one or more overlaid OFDM sequences. Additionally, or alternatively, the overlaid OFDM sequences carry part of (e.g., a subset of, a portion of) the information bits of the LP-WUS 604. The OFDM-based LP-WUR can obtain all of the information bits by the OFDM sequences and the location of the OFDM sequences and/or OOK symbols. Additionally, or alternatively, the overlaid OFDM sequences carry all of the information bits of the LP-WUS 604. The OFDM-based LP-WUR can obtain all of the information bits by the overlaid OFDM sequences.

In some other examples, the NE and/or the UE selects one sequence from a set of candidate overlaid OFDM sequences on one or more OOK ‘ON’ symbols. An OFDM-based LP-WUR obtains information bits of a LP-WUS 604 at least by one or more overlaid OFDM sequences. In some other examples, the NE and/or the UE may use a modulated overlay sequence with constellation points. For example, the NE and/or the UE may use the overlay sequence as a spreading sequence and one or more constellation points carry information for an OFDM-based LP-WUR.

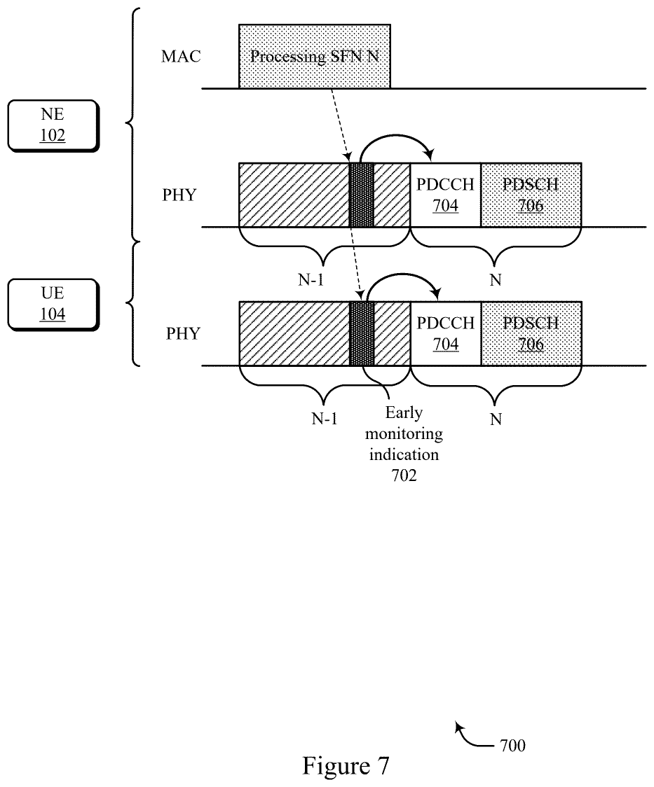

In some cases, the NE and/or the UE may implement a new WUS design, indication and procedure to reduce PDCCH monitoring or to indicate one or more blank subframes, which is described in further detail with respect to FIGS. 7 through 11. Thus, the UE may not perform PDCCH monitoring in each slot in a connected mode, which may reduce power consumption at the UE.

FIG. 7 illustrates an example transmission diagram 700 in accordance with aspects of the present disclosure. In some examples, the transmission diagram 700 implements aspects of the wireless communications system 100, the wireless communications system 200, the wireless communications system 300, the waveform diagram 400, the waveform diagram 500, and the waveform diagram 600. The transmission diagram 700 may be implemented by a NE 102 and a UE 104, which may be examples of a NE 102 and a UE 104 as described with reference to FIGS. 1 through 3. For example, a NE 102 may transmit an early monitoring indication 702 to a UE 104 to indicate to the UE 104 to monitor for one or more PDCCHs 704.

In same examples, the NE 102 and the UE 104 may implement a communication architecture that includes one or more layers, such as a medium access control (MAC) layer and a physical (PHY) layer, to manage data transmission and reception. The MAC layer may be responsible for controlling access to a physical medium, managing data flow, and performing addressing and data formatting. The PHY layer may be responsible for the transmission and reception of data over a physical medium, including modulation, coding, and signal processing.

At the NE 102, the MAC layer may exchange information with the PHY layer to coordinate transmission of data to the UE 104. The MAC layer at the NE 102 may determine when to transmit data, what type of data to transmit, and how to format the data for transmission. The MAC layer at the NE 102 may also perform scheduling, resource allocation, and prioritization of data streams. The PHY layer at the NE 102 may obtain the formatted data from the MAC layer and prepare the formatted data for transmission over a wireless channel. For example, the PHY layer may include processes such as encoding, modulation, and applying various signal processing techniques to the formatted data.

The PHY layer at the UE 104 may receive and process the signals transmitted by the NE 102. For example, the PHY layer at the UE 104 may perform tasks such as signal detection, demodulation, and decoding to extract the transmitted information. The PHY layer at the NE 102 may generate and transmit an early monitoring indication 702, while the PHY layer at the UE 104 may detect and process the early monitoring indication 702 to determine when and how to monitor for downlink control channel transmissions (e.g., the PDCCH 704).

In some examples, the NE 102 and/or the UE 104 may use a system frame number (SFN) as a timing reference for transmissions. The SFN may be a cyclically incremented counter that identifies a radio frame within a larger time cycle to provide for synchronization and timing coordination between the NE 102 and the UE 104. The SFN may correspond to a slot index, and may include an integer value, N. In some cases, the NE 102 may transmit the early monitoring indication 702 in an SFN, N−1, to indicate information related to a PDCCH 704 in an SFN, N, to the UE 104. Thus, the UE 104 may monitor for and receive the PDCCH 704 using the indicated information, which reduces power consumption at the UE 104 by reducing or avoiding PDCCH monitoring and/or blind search and deciding for the PDCCH 704. The NE 102 may configure the UE 104 to monitor for the early monitoring indication 702 at a slot N−1 to determine one or more resources to monitor for the PDCCH 704 at slot N. The NE 102 may provide (e.g., output, transmit, send) the early monitoring indication 702 to an individual UE (e.g., a single UE, such as the UE 102) or to a group of UEs.

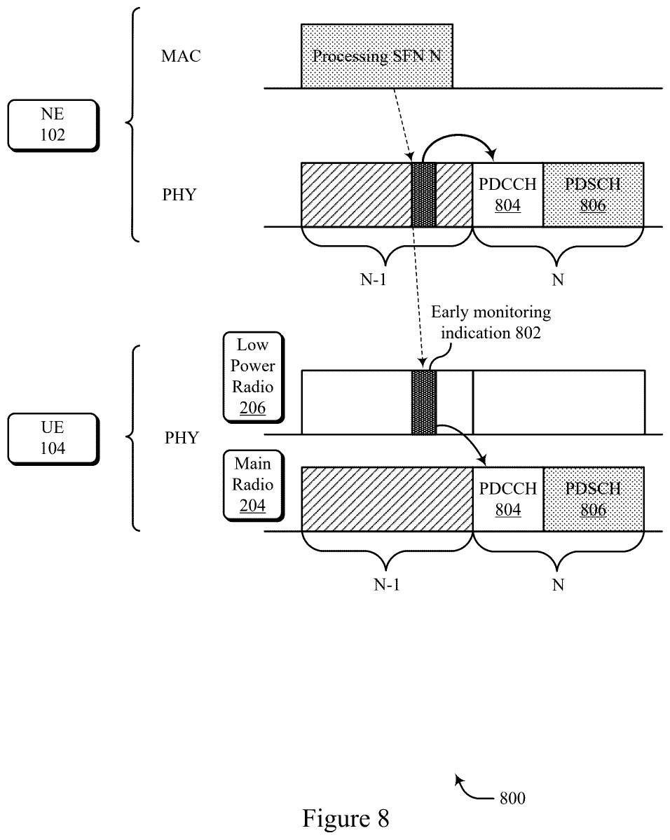

The NE 102 may use one or more sequences or modulated symbols to transmit the early monitoring indication 702. For example, the NE 102 may transmit the early monitoring indication 702 to the UE 104 in DCI. In some other examples, the NE 102 may transmit the early monitoring indication to the UE 104 in a WUS (e.g., to a LP-WUR of the UE 104 in a LP-WUS), which is described in further detail with respect to FIG. 8.

In some examples, the early monitoring indication 702 dynamically indicates whether or not the UE 104 is to monitor for a PDCCH 704 in a subsequent (e.g., next) slot. The UE 104 may monitor for the early monitoring indication 702 as a codepoint or a bitmap using a sequence or modulated symbols in configured monitoring. If the UE 104 detects the early monitoring indication 702, then UE 104 may monitor for the PDCCH 704 in a subsequent slot (e.g., a slot with SFN or index N if the early monitoring indication 702 is received in a slot with SFN or index N−1).

In some cases, the early monitoring indication 702 dynamically indicates a search space identifier and one or more search space monitoring occasions from a configured set. For example, in addition to, or as an alternative to, the indication for the UE 104 to monitor for the PDCCH 704 in a subsequent slot, the early monitoring indication 702 may include a search space identifier to monitor or an indication to perform search space group identifier switching. A codepoint or a bitmap included in the early monitoring indication 702 indicates search space group switching. The early monitoring indication 702 may dynamically indicate the monitoring occasions for a search space identifier.

The UE 104 may receive the early monitoring indication 702 in a slot with an index or SFN of N−1. In some cases, the early monitoring indication 702 dynamically indicates for the UE 104 to monitor for a PDCCH 704 in a numerical quantity of contiguous slots, M, from slot N, where M≥1. In some other cases, the early monitoring indication 702 dynamically indicates for the UE 104 to monitor for a PDCCH 704 in a numerical quantity of non-contiguous slots, P, from slot N, where P≥1. For example, a codepoint or a bitmap included in the early monitoring indication 702 indicates M contiguous slots or P non-contiguous slots in a radio frame, respectively. In some examples, the early monitoring indication 702 indicates which of the P non-contiguous slots the UE 104 is to monitor in a radio frame.

In some cases, the early monitoring indication 702 dynamically indicates whether or not there is a blank slot in a subsequent (e.g., next) slot. The UE 104 may refrain from (e.g., avoid, skip) monitoring for the PDCCH 704 in the subsequent slot based on the early monitoring indication 702 indicating the blank slot. The early monitoring indication 702 may indicate a numerical quantity of contiguous or non-contiguous slots in a radio frame for which the PDCCH 704 is skipped (e.g., the blank slots). If the early monitoring indication 702 indicates the PDCCH 704 is skipped and the UE 104 is not monitoring for the PDCCH 704, then the UE 104 may be configured to monitor for a PDCCH monitoring resume request. For example, the NE 102 may configure the UE 104 to monitor for a PDCCH monitoring resume request in a DCI or a LP-WUS within a defined time period or duration, referred to as a skipping duration.

In some examples, the early monitoring indication 702 may reduce (e.g., minimize) blind search or blind decoding of the PDCCH 704 by providing additional information about the PDCCH blind decoding in one or more subsequent slots. The additional information may include, but is not limited to, a DCI format to monitor, a search space identifier, or a candidate and aggregation level to monitor, among other examples. In some cases, the early monitoring indication 702 may include a codepoint or a bitmap that indicates the additional information. Additionally, or alternatively, a codepoint or bitmap may provide information about whether the UE 104 is to monitor for the PDCCH 704 in a common search space or a UE specific search space (e.g., including a UE search space identifier). In some examples, a separate LP-WUS resource occasion can be configured to monitor for each dedicated CORESET.

The NE 102 may process signaling in a slot with an SFN, N, at the MAC layer and may determine that the slot includes a PDCCH 704. The NE 102 may determine to include the early monitoring indication 702 at the PHY layer in a slot with an SFN, N−1, in response to determining that the slot, N, includes the PDCCH 704. The UE 104 may receive the early monitoring indication 702 in the slot with the SFN, N−1, at the PHY layer. The UE 104 may determine from the early monitoring indication 702 whether to monitor for the PDCCH 704 in the slot with the SFN, N, accordingly. The PDCCH 704 may schedule a corresponding physical downlink shared channel (PDSCH) 706. For example, the PDCCH 704 may include control signaling (e.g., DCI) that includes one or more time-frequency resources or other configuration information for monitoring for and decoding the PDSCH 706. The PDSCH 706 may include data. A codepoint or payload in a first LP-WUS may indicate PDCCH monitoring for N slots, while an extra information codepoint or payload in a second LP-WUS can be monitored in the N slots before DCI decoding (e.g., previous slot or N symbols before CORESET symbol in each slot). The UE 104 can be configured with the first LP-WUS and the second LP-WUS with different periodicities and monitoring occasions. Additionally, or alternatively, the first LP-WUS and/or the second LP-WUS may be activate and deactivate separately using L1 and/or L2 signaling.

FIG. 8 illustrates an example transmission diagram 800 in accordance with aspects of the present disclosure. In some examples, the transmission diagram 800 implements aspects of the wireless communications system 100, the wireless communications system 200, the wireless communications system 300, the waveform diagram 400, the waveform diagram 500, the waveform diagram 600, and the transmission diagram 700. The transmission diagram 800 may be implemented by a NE and a UE, which may be examples of a NE 102 and a UE 104 as described with reference to FIGS. 1 through 3. For example, the UE 104 may include a main radio 204 and a low power radio 206, as described with reference to FIG. 2. A NE 102 may transmit an early monitoring indication 802 to a UE 104 that includes information for monitoring for a PDCCH 804.

In some examples, the UE 104 and/or the NE 102 may implement a communication architecture with one or more layers, including the MAC layer and the PHY layer, as described with reference to FIG. 7. In some examples, at the PHY layer, the UE 104 may receive an early monitoring indication 802 using a low power radio 206. For example, the NE 102 may transmit the early monitoring indication 802 to the UE 104 in a LP-WUS, which the low power radio 206 of the UE 104 receives. The UE 104 may wake-up a main radio 204 responsive to the LP-WUS and may monitor for a PDCCH 804 using the information in the early monitoring indication 802, as described with reference to FIG. 7. For example, the UE 104 may monitor for the PDCCH 804 in one or more consecutive or non-consecutive subsequent slots (e.g., a slot with an SFN or index, N, if the early monitoring indication is received in a slot with an SFN or index, N−1).

The NE 102 may process signaling in a slot with an SFN, N, at the MAC layer and may determine that the slot includes a PDCCH 804. The NE 102 may determine to include the early monitoring indication 802 in a LP-WUS at the PHY layer. The NE 102 may include the early monitoring indication 802 in a slot with an SFN, N−1, in response to determining that the slot, N, includes the PDCCH 804. The UE 104 may receive the early monitoring indication 802 in the slot with the SFN, N−1, at the PHY layer. The UE 104 may determine from the early monitoring indication 802 whether to wake-up the main radio 204 to monitor for the PDCCH 804 in the slot with the SFN, N, accordingly. The PDCCH 804 may schedule a corresponding PDSCH 806. For example, the PDCCH 804 may include control signaling (e.g., DCI) that includes one or more time-frequency resources or other configuration information for monitoring for and decoding the PDSCH 806. The main radio 204 may monitor for and receive the PDCCH 804 and the PDSCH 806.

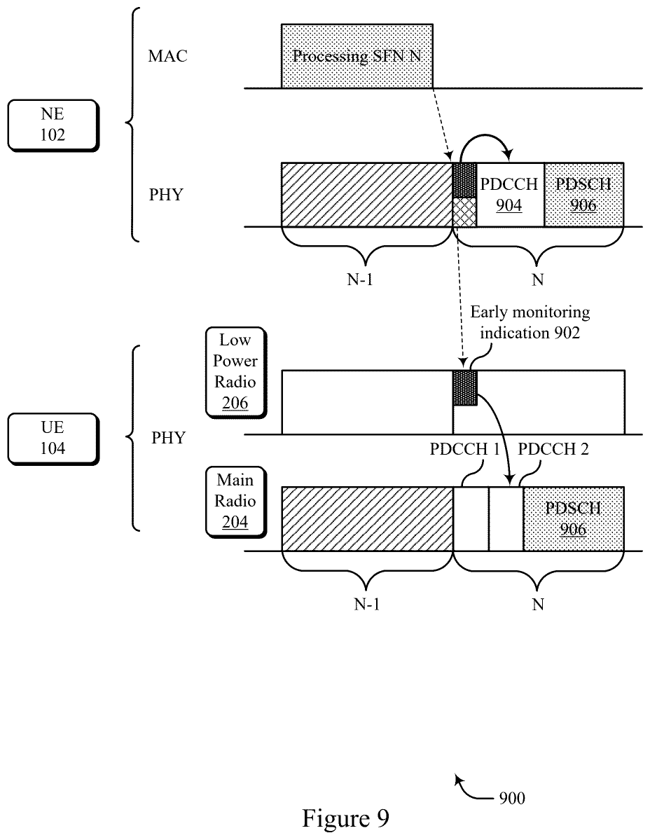

FIG. 9 illustrates an example transmission diagram 900 in accordance with aspects of the present disclosure. In some examples, the transmission diagram 900 implements aspects of the wireless communications system 100, the wireless communications system 200, the wireless communications system 300, the waveform diagram 400, the waveform diagram 500, the waveform diagram 600, the transmission diagram 700, and the transmission diagram 800. The transmission diagram 900 may be implemented by a NE and a UE, which may be examples of a NE 102 and a UE 104 as described with reference to FIGS. 1 through 3. For example, the UE 104 may include a low power radio 206 and a main radio 204, as described with reference to FIG. 2. A NE 102 may transmit an early monitoring indication 902 to a UE 104 that includes information for monitoring for a PDCCH 904.

In some examples, the UE 104 and/or the NE 102 may implement a communication architecture with one or more layers, including the MAC layer and the PHY layer, as described with reference to FIG. 7. In some cases, the NE 102 may configure the UE 102 to monitor for an early monitoring indication 902 at the beginning of a slot to determine whether to monitor for a PDCCH 904 in that slot. For example, the NE 102 may transmit the early monitoring indication 902 at the beginning of a slot with an SFN or index, N, where the slot includes one or more PDCCHs 904. If the UE 104 includes a low power radio 206, then the NE 102 may transmit the early monitoring indication 902 to the UE 104 in a LP-WUS. The NE 102 may assign one or more resources for the LP-WUS at the beginning of a slot, such as in a symbol of the slot with an index of zero. The NE 102 may configure one or more PDCCH monitoring symbols corresponding to the LP-WUS from a symbol following the early monitoring indication 902, such as from a symbol in the slot with an index of one. For example, the NE 102 may indicate a dedicated CORESET or dedicated search space from the symbol following the early monitoring indication 902, where the dedicated search space of the dedicated CORESET are linked to a LP-WUS monitoring resource. In some cases, there may be two dedicated CORESETs configured in a slot, where the first CORESET can be configured from the beginning of the slot boundary and may not be linked to the LP-WUS (e.g., including the PDCCH 1). One or more UEs that are not configured to monitor for a LP-WUS at the beginning of the slot can be configured to monitor the first CORESET. One or more UEs that are configured to monitor for the LP-WUS at the beginning of the slot can be configured to monitor a second CORESET (e.g., including the PDCCH 2).

The NE 102 may process signaling in a slot with an SFN, N, at the MAC layer and may determine that the slot includes a PDCCH 904. The NE 102 may determine to include the early monitoring indication 902 in a LP-WUS at the PHY layer. The NE 102 may include the early monitoring indication 902 in at the beginning of a slot that includes the PDCCH 904, in response to determining that the slot, N, includes the PDCCH 904. The UE 104 may receive the early monitoring indication 902 in the slot with the SFN, N, at the PHY layer. The UE 104 may determine from the early monitoring indication 902 whether to wake-up the main radio 204 to monitor for a PDCCH 904 in the slot with the SFN, N, accordingly (e.g., the PDCCH 2). The PDCCH 904 may schedule a corresponding PDSCH 906. For example, the PDCCH 904 may include control signaling (e.g., DCI) that includes one or more time-frequency resources or other configuration information for monitoring for and decoding the PDSCH 906. The main radio 204 may monitor for and receive the PDCCH 904 (e.g., the PDCCH 2) and the PDSCH 906.

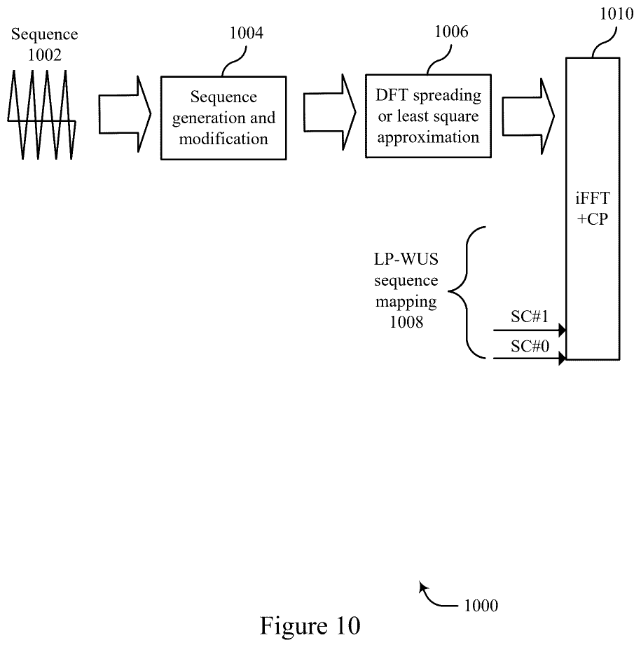

FIG. 10 illustrates an example waveform diagram 1000 in accordance with aspects of the present disclosure. In some examples, the waveform diagram 1000 implements aspects of the wireless communications system 100, the wireless communications system 200, the wireless communications system 300, the waveform diagram 400, the waveform diagram 500, the waveform diagram 600, the transmission diagram 700, the transmission diagram 800, and the transmission diagram 900. The waveform diagram 1000 may be implemented by a NE and a UE, which may be examples of a NE 102 and a UE 104 as described with reference to FIGS. 1 through 3. For example, a NE and/or a UE may implement a sequence design illustrated in the waveform diagram 1000 for transmitting NR signaling and/or a LP-WUS, among other signaling.

In some cases, a NE and/or a UE may obtain a sequence 1002 representative of a signal (e.g., including control signaling and/or data) for transmission. At 1004, the NE and/or the UE may perform sequence generation and modification for the sequence 1002. For example, the NE and/or the UE may generate an orthogonal Zandoff-Chu sequence using a cyclic shift. In some other examples, a UE or a group of UEs may receive (e.g., obtain, may be provided with) a generated sequence. At 1006, the NE and/or the UE may apply DFT spreading or least square approximation to the generated sequence. For example, the NE and/or the UE may apply a DFT-s-spread to the generated sequence within a LP-WUS bandwidth. At 1008, the NE and/or the UE may perform LP-WUS sequence mapping. For example, the NE and/or the UE may map the LP-WUS sequence to legacy channels in an IFFT grid 1010. A number of chips of sequences within an OFDM symbol can be indicated using an M value. The NE and/or the UE may multiplex one or more monitoring occasion in a time domain, a frequency domain, and/or a code domain to indicate one or more UEs.

In some examples, a codepoint or bitmap bits of an early monitoring indication can be divided into N groups of Q bits in each group. Two power Q sequences can be configured to represent those in a LP-WUS occasion, and each sequence represent Q bits. For example, a first sequence can represent a first Q bits and a second sequence can represent a second Q bits, etc. In some examples, there can be an ‘M’ sequence before DFT spreading per OFDM symbol, and each sequence represents a group of Q bits. There can be OOK-4, M=4 chips per OFDM symbol, and the sequence are transmitted in the ON duration of OOK-4. Both group of sequences and OOK-4 chips represent the 5G-s-TMSI. For example, In CONNECTED mode, a LP-WUS can at least trigger PDCCH monitoring when downlink traffic arrives. Different UEs may have different traffic arrival time, as well as different latency criteria (e.g., requirements, thresholds). Therefore, for CONNECTED mode, a LP-WUS may include per-UE information. In some examples NR systems (e.g., conventional or legacy NR systems), a 16-bit RNTI is used to uniquely identify a UE in CONNECTED mode. Therefore, up to 16 bits are used for a LP-WUS in CONNECTED mode. The 16 bits can be segmented into 4 groups of 4 bits each, while 4 chips can be transmitted using DFT spread sequence in a OFDM symbol. Thus, 4 OFDM symbols convey 16 bits. In some other examples, extra (e.g., additional) information to reduce blind decoding complexity, such as the search space identifier to monitor, slots to monitor for PDCCH, DCI formats to monitor within PDCCH, aggregation level or candidate location to monitor for DCI etc., can be transmitted as LP-WUS payload. In some other examples, the extra information can also be transmitted as a DCI payload while the RNTI can be scrambled with a cyclic redundancy check (CRC), in that a new DCI format for the DCI payload and monitoring occasion for the DCI may be configured.

In some other examples, each UE monitoring LP-WUS occasion can be provided with a defined sequence transmitted in a LP-WUS occasion. Each UE monitoring a LP-WUS occasion can be configured with a unique sequence. A successful reception of a sequence implies successful reception of an early monitoring indication. As there are a finite numerical quantity of sequences, the same sequence can be repeated in another LP-WUS occasion configured to be monitored by another UE for an early monitoring indication. In some other examples, a base sequence using a sequence identifier can be configured for a LP-WUS occasion. Each UE with an early monitoring indication can have a unique cyclic shift generating orthogonal sequence from the base sequence. The early monitoring indication can be code division multiplexed (CDM) using cyclic shifts. In some other examples, multiple codepoints are configured for a UE in a monitoring occasion. For example, a first codepoint represents an early monitoring indication, a second codepoint represents a search space identifier, search space switch group switching, or a dynamic indication of a search space identifier to monitor, a third codepoint indicates a DCI format to monitor, etc. Each codepoint can be configured with a sequence for the UE. In some examples, codepoints can be transmitted with different monitoring occasions, the PDCCH monitoring can be transmitted with less periodicity while codepoints associated with extra information that reduces the DCI decoding complexity can be transmitted more often. The codepoint may indicate PDCCH monitoring for N slots while extra information codepoints can be monitored in those N slots before DCI decoding (e.g., previous slot or N symbols before CORESET symbol in each slot). Additionally, or alternatively, a combination of the described options is possible.

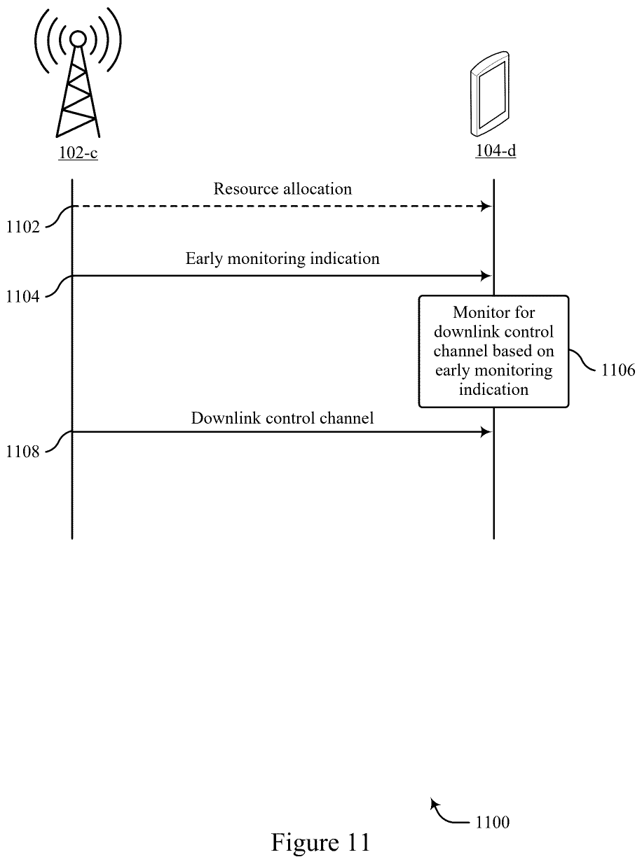

FIG. 11 illustrates an example signaling diagram 1100 in accordance with aspects of the present disclosure. In some examples, the signaling diagram 1100 may implement aspects of the waveform diagram 1000 implements aspects of the wireless communications system 100, the wireless communications system 200, the wireless communications system 300, the waveform diagram 400, the waveform diagram 500, the waveform diagram 600, the transmission diagram 700, the transmission diagram 800, the transmission diagram 900, and the waveform diagram 1000. The signaling diagram 1100 may implement, or may be implemented by, a NE 102-c and a UE 104-d, which may be examples of a NE 102 and a UE 104 as described with reference to FIGS. 1 through 3. For example, the signaling diagram 1100 may illustrate an example of a NE 102-c transmitting an early monitoring indication to a UE 104-d to reduce computational resource usage at the UE 104-d related to monitoring for and decoding downlink control channel transmissions. Alternative examples of the following may be implemented, where some processes are performed in a different order than described or are not performed. In some cases, processes may include additional features not mentioned below, or further processes may be added.

In some examples, the UE 104-d may include multiple radios, such as a low power radio and a main radio as described with reference to FIG. 2. In some other examples, the UE 104-d may include a single radio.

At 1102, the NE 102-c transmits a resource allocation to the UE 104-d. The resource allocation may indicate a first resource in a time domain during which the UE 104-d is to receive an early monitoring indication. For example, the NE 102-c may transmit control signaling (e.g., RRC signaling, DCI, a medium access control-control element (MAC-CE)) that indicates the resource allocation for an early monitoring indication.

At 1104, the NE 102-c transmits an early monitoring indication to the UE 104-d during the first resource in the time domain. The early monitoring indication indicates a second resource in the time domain and/or provides information associated with blind decoding of a downlink control channel. For example, the early monitoring indication may indicate one or more consecutive or non-consecutive slots during which the UE 104-d is to monitor for a PDCCH. In some examples, the early monitoring indication includes a codepoint or bitmap and is transmitted using a sequence or one or more modulated symbols in one or more resources in the time domain including the first resource.

In some cases, the NE 102-c transmits the early monitoring indication in DCI. In some other cases, the NE 102-c transmits the early monitoring indication in a WUS (e.g., a LP-WUS received via a first radio of the UE 104-d for activating a second radio). The early monitoring indication may include, but is not limited to, a search space to monitor, a search space identifier associated with one or more monitoring occasions, a codepoint associated with search space group switching, or a bitmap associated with the search space group switching.

In some examples, the early monitoring indication includes a codepoint or a bitmap indicating a set of consecutive or non-consecutive resources in the time domain that include a downlink control channel (e.g., a PDCCH). Additionally, or alternatively, the early monitoring indication includes an indication of at least one third resource in the time domain without the downlink control channel (e.g., one or more slots that do not include a PDCCH). Additionally, or alternatively, the early monitoring indication includes a codepoint or a bitmap indicating a DCI format to monitor, a search space identifier, a candidate level to monitor, or an aggregation level to monitor for the blind decoding of the downlink control channel.

In some cases, the early monitoring indication includes an indication of at least one of a CORESET or a search space for the first resource. The early monitoring indication may be associated with a group of UEs including the UE 104-d based on at least one of a sequence of the early monitoring indication or a modulated symbol of the early monitoring indication. Additionally, or alternatively, the early monitoring indication may be associated with an orthogonal Zandoff-Chu sequence generated using a cyclic shift, where the orthogonal Zandoff-Chu sequence is spread based on one or more frequency resources associated with the early monitoring indication.

At 1106, the UE 104-d monitors for the downlink control channel based on the early monitoring indication. For example, the UE 104-d may monitor the second resource in the time domain for the downlink control channel. In some other examples, the UE 104-d may monitor one or more search spaces, may monitor for a DCI format, may monitor for an aggregation level, or may monitor for a candidate level, according to the information associated with the blind decoding of the downlink control channel provided in the early monitoring indication. If the early monitoring indication indicates a third resource without the downlink control channel, then the UE 104-d refrains from monitoring (e.g., skips, does not monitor) for the downlink control channel during the third resource.

At 1108, the NE 102-c transmits the downlink control channel (e.g., PDCCH) to the UE 104-d based on the information provided in the early monitoring indication.

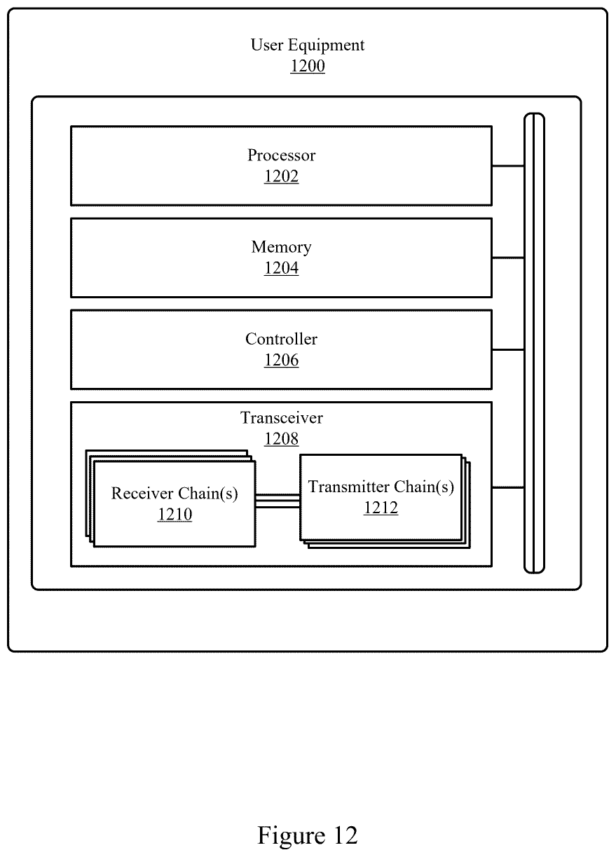

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving, during a first resource in a time domain, an early monitoring indication that indicates a second resource in the time domain and information associated with blind decoding of a downlink control channel, and monitoring, based on the second resource in the time domain and the information associated with the blind decoding of the downlink control channel, for the downlink control channel.

Additionally, the UE 1200 may be configured to support any one or combination of monitoring for the early monitoring indication based on at least one of a codepoint or a bitmap using a sequence or one or more modulated symbols in one or more resources in the time domain including the first resource. Additionally, or alternatively, the UE 1200 may be configured to support the early monitoring indication includes at least one of a search space to monitor, a search space identifier associated with one or more monitoring occasions, a codepoint associated with search space group switching, or a bitmap associated with the search space group switching. Additionally, or alternatively, the UE 1200 may be configured to support the early monitoring indication includes at least one of a codepoint or a bitmap that indicates a set of consecutive resources in the time domain that include the downlink control channel, and where the set of consecutive resources includes the second resource. Additionally, or alternatively, the early monitoring indication includes at least one of a codepoint or a bitmap that indicates a set of non-consecutive resources in the time domain that include the downlink control channel, where the UE 1200 may be configured to support monitoring, based on the set of non-consecutive resources in the time domain, for the downlink control channel.

Additionally, or alternatively, the early monitoring indication indicates at least one third resource in the time domain without the downlink control channel, where the UE 1200 may be configured to support refraining from monitoring for the downlink control channel during the at least one third resource. Additionally, or alternatively, the UE 1200 may be configured to support the information includes at least one of a codepoint or a bitmap that indicates a DCI format to monitor, a search space identifier, a candidate level to monitor, or an aggregation level to monitor for the blind decoding of the downlink control channel. Additionally, or alternatively, the UE 1200 includes a first radio and a second radio, where to receive the early monitoring indication, the UE 1200 may be configured to support receiving, via the first radio, a WUS for activating the second radio that includes the early monitoring indication. Additionally, or alternatively, to receive the early monitoring indication, the UE 1200 may be configured to support receiving DCI including the early monitoring indication.

Additionally, or alternatively, the UE 1200 may be configured to support receiving signaling that indicates the first resource. Additionally, or alternatively, the UE 1200 may be configured to support the early monitoring indication is associated with a group of UEs including the UE based on at least one of a sequence of the early monitoring indication or a modulated symbol of the early monitoring indication. Additionally, or alternatively, the UE 1200 may be configured to support the early monitoring indication indicates at least one of a CORESET or a search space corresponding to the first resource, and where the second resource is based on the at least one of the CORESET or the search space. Additionally, or alternatively, the UE 1200 may be configured to support the early monitoring indication is associated with an orthogonal Zandoff-Chu sequence generated using a cyclic shift, and where the orthogonal Zandoff-Chu sequence is spread based on one or more frequency resources associated with the early monitoring indication.

Additionally, or alternatively, the UE 1200 may support at least one memory (e.g., the memory 1204) and at least one processor (e.g., the processor 1202) coupled with the at least one memory and configured to cause the UE to receive, during a first resource in a time domain, an early monitoring indication that indicates a second resource in the time domain and information associated with blind decoding of a downlink control channel, and monitor, based on the second resource in the time domain and the information associated with the blind decoding of the downlink control channel, for the downlink control channel.

Additionally, to receive the early monitoring indication, the UE 1200 may be configured to support any one or combination of to monitor for the early monitoring indication based on at least one of a codepoint or a bitmap using a sequence or one or more modulated symbols in one or more resources in the time domain including the first resource. Additionally, or alternatively, the UE 1200 may be configured to support the early monitoring indication includes at least one of a search space to monitor, a search space identifier associated with one or more monitoring occasions, a codepoint associated with search space group switching, or a bitmap associated with the search space group switching. Additionally, or alternatively, the UE 1200 may be configured to support the early monitoring indication includes at least one of a codepoint or a bitmap that indicates a set of consecutive resources in the time domain that include the downlink control channel, and where the set of consecutive resources includes the second resource.

Additionally, or alternatively, the early monitoring indication includes at least one of a codepoint or a bitmap that indicates a set of non-consecutive resources in the time domain that include the downlink control channel, and the UE 1200 may be configured to support to monitor, based on the set of non-consecutive resources in the time domain, for the downlink control channel. Additionally, or alternatively, the early monitoring indication indicates at least one third resource in the time domain without the downlink control channel, and the UE 1200 may be configured to support to refrain from monitoring for the downlink control channel during the at least one third resource. Additionally, or alternatively, the UE 1200 may be configured to support the information includes at least one of a codepoint or a bitmap that indicates a DCI format to monitor, a search space identifier, a candidate level to monitor, or an aggregation level to monitor for the blind decoding of the downlink control channel. Additionally, or alternatively, the UE 1200 includes a first radio and a second radio, and to receive the early monitoring indication, the UE 1200 may be configured to support to receive, via the first radio, a WUS for activating the second radio that includes the early monitoring indication. Additionally, or alternatively, to receive the early monitoring indication the UE 1200 may be configured to support to receive DCI including the early monitoring indication.

Additionally, or alternatively, the UE 1200 may be configured to support to receive signaling that indicates the first resource. Additionally, or alternatively, the UE 1200 may be configured to support the early monitoring indication is associated with a group of UEs including the UE based on at least one of a sequence of the early monitoring indication or a modulated symbol of the early monitoring indication. Additionally, or alternatively, the UE 1200 may be configured to support the early monitoring indication indicates at least one of a CORESET or a search space corresponding to the first resource, and where the second resource is based on the at least one of the CORESET or the search space. Additionally, or alternatively, the UE 1200 may be configured to support the early monitoring indication is associated with an orthogonal Zandoff-Chu sequence generated using a cyclic shift, and where the orthogonal Zandoff-Chu sequence is spread based on one or more frequency resources associated with the early monitoring indication.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

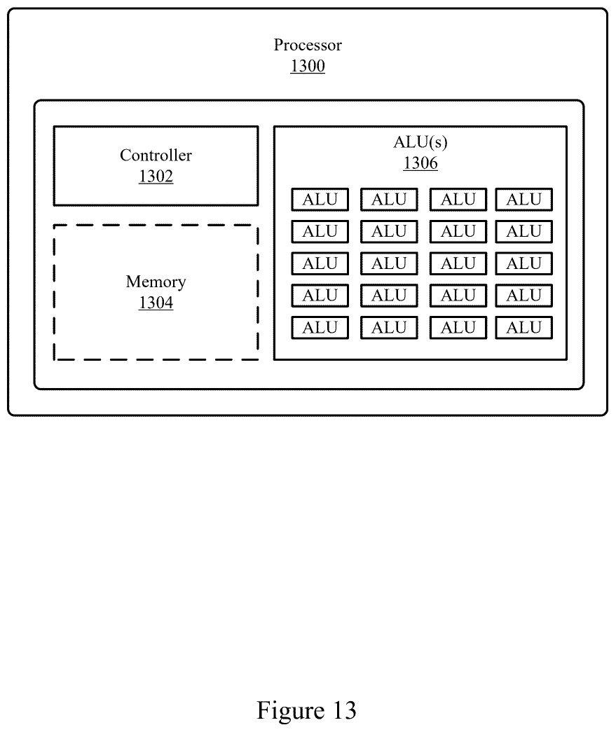

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive, during a first resource in a time domain, an early monitoring indication that indicates a second resource in the time domain and information associated with blind decoding of a downlink control channel, and monitor, based on the second resource in the time domain and the information associated with the blind decoding of the downlink control channel, for the downlink control channel.

Additionally, to receive the early monitoring indication, the processor 1300 may be configured to support any one or combination of to monitor for the early monitoring indication based on at least one of a codepoint or a bitmap using a sequence or one or more modulated symbols in one or more resources in the time domain including the first resource. Additionally, or alternatively, the processor 1300 may be configured to support the early monitoring indication includes at least one of a search space to monitor, a search space identifier associated with one or more monitoring occasions, a codepoint associated with search space group switching, or a bitmap associated with the search space group switching. Additionally, or alternatively, the processor 1300 may be configured to support the early monitoring indication includes at least one of a codepoint or a bitmap that indicates a set of consecutive resources in the time domain that include the downlink control channel, and where the set of consecutive resources includes the second resource. Additionally, or alternatively, the early monitoring indication includes at least one of a codepoint or a bitmap that indicates a set of non-consecutive resources in the time domain that include the downlink control channel, where the processor 1300 may be configured to support to monitor, based on the set of non-consecutive resources in the time domain, for the downlink control channel.

Additionally, or alternatively, the early monitoring indication indicates at least one third resource in the time domain without the downlink control channel, where the processor 1300 may be configured to support to refrain from monitoring for the downlink control channel during the at least one third resource. Additionally, or alternatively, the processor 1300 may be configured to support the information includes at least one of a codepoint or a bitmap that indicates a DCI format to monitor, a search space identifier, a candidate level to monitor, or an aggregation level to monitor for the blind decoding of the downlink control channel. Additionally, or alternatively, the processor 1300 implements a first radio and a second radio, where to receive the early monitoring indication, the processor 1300 may be configured to support to receive, via the first radio, a WUS for activating the second radio that includes the early monitoring indication. Additionally, or alternatively, to receive the early monitoring indication, the processor 1300 may be configured to support to receive DCI including the early monitoring indication.

Additionally, or alternatively, the processor 1300 may be configured to support to receive signaling that indicates the first resource. Additionally, or alternatively, the processor 1300 may be configured to support the early monitoring indication is associated with a group of UEs associated with the processor 1300 based on at least one of a sequence of the early monitoring indication or a modulated symbol of the early monitoring indication. Additionally, or alternatively, the processor 1300 may be configured to support the early monitoring indication indicates at least one of a CORESET or a search space corresponding to the first resource, and where the second resource is based on the at least one of the CORESET or the search space. Additionally, or alternatively, the processor 1300 may be configured to support the early monitoring indication is associated with an orthogonal Zandoff-Chu sequence generated using a cyclic shift, and where the orthogonal Zandoff-Chu sequence is spread based on one or more frequency resources associated with the early monitoring indication.

The processor 1300 may be configured to or operable to support at least one controller (e.g., the controller 1302) coupled with at least one memory (e.g., the memory 1304) and configured to cause the processor to transmit, during a first resource in a time domain, an early monitoring indication that indicates a second resource in the time domain and information associated with blind decoding of a downlink control channel, and transmit, based on the second resource in the time domain and the information associated with the blind decoding of the downlink control channel, the downlink control channel.

Additionally, to transmit the early monitoring indication, the processor 1300 may be configured to support any one or combination of to transmit the early monitoring indication based on at least one of a codepoint or a bitmap using a sequence or one or more modulated symbols in one or more resources in the time domain including the first resource. Additionally, or alternatively, the processor 1300 may be configured to support the early monitoring indication includes at least one of a search space to monitor, a search space identifier associated with one or more monitoring occasions, a codepoint associated with search space group switching, or a bitmap associated with the search space group switching. Additionally, or alternatively, the processor 1300 may be configured to support the early monitoring indication includes at least one of a codepoint or a bitmap that indicates a set of consecutive resources in the time domain that include the downlink control channel, and where the set of consecutive resources includes the second resource. Additionally, or alternatively, the early monitoring indication includes at least one of a codepoint or a bitmap that indicates a set of non-consecutive resources in the time domain that include the downlink control channel, where the processor 1300 may be configured to support any one or combination of to transmit, based on the set of non-consecutive resources in the time domain, the downlink control channel.

Additionally, or alternatively, the early monitoring indication indicates at least one third resource in the time domain without the downlink control channel, where the processor 1300 may be configured to support to refrain from transmitting the downlink control channel during the at least one third resource. Additionally, or alternatively, the processor 1300 may be configured to support the information includes at least one of a codepoint or a bitmap that indicates a DCI format for a UE to monitor, a search space identifier, a candidate level for the UE to monitor, or an aggregation level for the UE to monitor for the blind decoding of the downlink control channel. Additionally, or alternatively, to transmit the early monitoring indication, the processor 1300 may be configured to support any one or combination of to transmit, to a first radio associated with a UE, a WUS for activating a second radio associated with the UE, and where the WUS includes the early monitoring indication. Additionally, or alternatively, to transmit the early monitoring indication the processor 1300 may be configured to support to transmit DCI including the early monitoring indication.

Additionally, or alternatively, the processor 1300 may be configured to support to transmit signaling that indicates the first resource. Additionally, or alternatively, the processor 1300 may be configured to support the early monitoring indication is associated with a group of UEs based on at least one of a sequence of the early monitoring indication or a modulated symbol of the early monitoring indication. Additionally, or alternatively, the processor 1300 may be configured to support the early monitoring indication indicates at least one of a CORESET or a search space corresponding to the first resource, and where the second resource is based on the at least one of the CORESET or the search space. Additionally, or alternatively, the processor 1300 may be configured to support the early monitoring indication is associated with an orthogonal Zandoff-Chu sequence generated using a cyclic shift, and where the orthogonal Zandoff-Chu sequence is spread based on one or more frequency resources associated with the early monitoring indication.

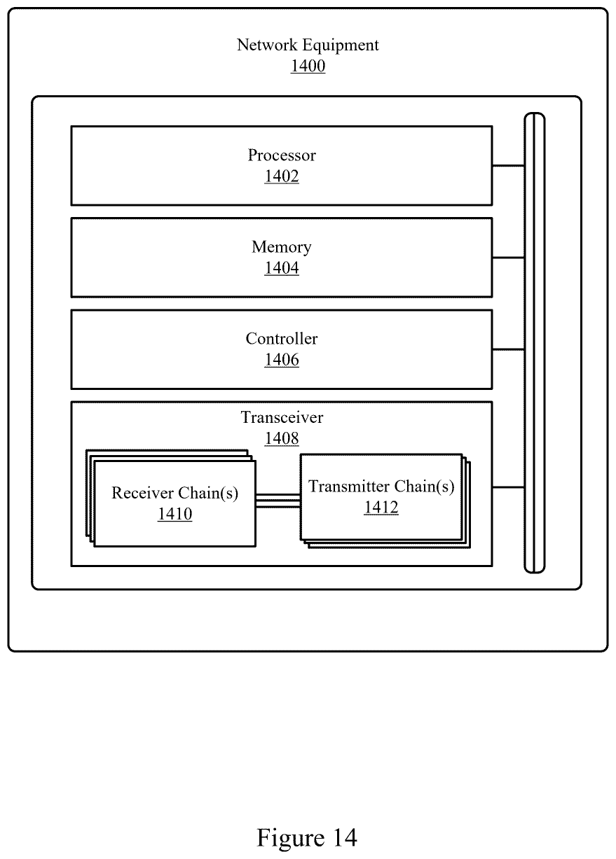

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for transmitting, during a first resource in a time domain, an early monitoring indication that indicates a second resource in the time domain and information associated with blind decoding of a downlink control channel, and transmitting, based on the second resource in the time domain and the information associated with the blind decoding of the downlink control channel, the downlink control channel.

Additionally, to transmit the early monitoring indication, the NE 1400 may be configured to or operable to support transmitting the early monitoring indication based on at least one of a codepoint or a bitmap using a sequence or one or more modulated symbols in one or more resources in the time domain including the first resource. Additionally, or alternatively, the NE 1400 may be configured to support the early monitoring indication includes at least one of a search space to monitor, a search space identifier associated with one or more monitoring occasions, a codepoint associated with search space group switching, or a bitmap associated with the search space group switching. Additionally, or alternatively, the NE 1400 may be configured to support the early monitoring indication includes at least one of a codepoint or a bitmap that indicates a set of consecutive resources in the time domain that include the downlink control channel, and where the set of consecutive resources includes the second resource. Additionally, or alternatively, the early monitoring indication includes at least one of a codepoint or a bitmap that indicates a set of non-consecutive resources in the time domain that include the downlink control channel, where the NE 1400 may be configured to or operable to support transmitting, based on the set of non-consecutive resources in the time domain, the downlink control channel.

Additionally, or alternatively, the early monitoring indication indicates at least one third resource in the time domain without the downlink control channel, where the NE 1400 may be configured to support refraining from transmitting the downlink control channel during the at least one third resource. Additionally, or alternatively, the NE 1400 may be configured to support the information includes at least one of a codepoint or a bitmap that indicates a DCI format for a UE to monitor, a search space identifier, a candidate level for the UE to monitor, or an aggregation level for the UE to monitor for the blind decoding of the downlink control channel. Additionally, or alternatively, to transmit the early monitoring indication, the NE 1400 may be configured to or operable to support transmitting, to a first radio associated with a UE, a WUS for activating a second radio associated with the UE, and where the WUS includes the early monitoring indication. Additionally, or alternatively, to transmit the early monitoring indication, the NE 1400 may be configured to or operable to support transmitting DCI including the early monitoring indication.

Additionally, or alternatively, the NE 1400 may be configured to support transmitting signaling that indicates the first resource. Additionally, or alternatively, the NE 1400 may be configured to support the early monitoring indication is associated with a group of UEs based on at least one of a sequence of the early monitoring indication or a modulated symbol of the early monitoring indication. Additionally, or alternatively, the NE 1400 may be configured to support the early monitoring indication indicates at least one of a CORESET or a search space corresponding to the first resource, and where the second resource is based on the at least one of the CORESET or the search space. Additionally, or alternatively, the NE 1400 may be configured to support the early monitoring indication is associated with an orthogonal Zandoff-Chu sequence generated using a cyclic shift, and where the orthogonal Zandoff-Chu sequence is spread based on one or more frequency resources associated with the early monitoring indication.

Additionally, or alternatively, the NE 1400 may support at least one memory (e.g., the memory 1404) and at least one processor (e.g., the processor 1402) coupled with the at least one memory and configured to cause the NE to transmit, during a first resource in a time domain, an early monitoring indication that indicates a second resource in the time domain and information associated with blind decoding of a downlink control channel, and transmit, based on the second resource in the time domain and the information associated with the blind decoding of the downlink control channel, the downlink control channel.

Additionally, to transmit the early monitoring indication, the NE 1400 may be configured to support to transmit the early monitoring indication based on at least one of a codepoint or a bitmap using a sequence or one or more modulated symbols in one or more resources in the time domain including the first resource. Additionally, or alternatively, the NE 1400 may be configured to support the early monitoring indication includes at least one of a search space to monitor, a search space identifier associated with one or more monitoring occasions, a codepoint associated with search space group switching, or a bitmap associated with the search space group switching. Additionally, or alternatively, the NE 1400 may be configured to support the early monitoring indication includes at least one of a codepoint or a bitmap that indicates a set of consecutive resources in the time domain that include the downlink control channel, and where the set of consecutive resources includes the second resource. Additionally, or alternatively, the early monitoring indication includes at least one of a codepoint or a bitmap that indicates a set of non-consecutive resources in the time domain that include the downlink control channel, where the NE 1400 may be configured to support to transmit, based on the set of non-consecutive resources in the time domain, the downlink control channel.

Additionally, or alternatively, the early monitoring indication indicates at least one third resource in the time domain without the downlink control channel, where the NE 1400 may be configured to support to refrain from transmitting the downlink control channel during the at least one third resource. Additionally, or alternatively, the NE 1400 may be configured to support the information includes at least one of a codepoint or a bitmap that indicates a DCI format for a UE to monitor, a search space identifier, a candidate level for the UE to monitor, or an aggregation level for the UE to monitor for the blind decoding of the downlink control channel. Additionally, or alternatively, to transmit the early monitoring indication, the NE 1400 may be configured to support to transmit, to a first radio associated with a UE, a WUS for activating a second radio associated with the UE, and where the WUS includes the early monitoring indication. Additionally, or alternatively, to transmit the early monitoring indication, the NE 1400 may be configured to support to transmit DCI including the early monitoring indication.

Additionally, or alternatively, the NE 1400 may be configured to support to transmit signaling that indicates the first resource. Additionally, or alternatively, the NE 1400 may be configured to support the early monitoring indication is associated with a group of UEs based on at least one of a sequence of the early monitoring indication or a modulated symbol of the early monitoring indication. Additionally, or alternatively, the NE 1400 may be configured to support the early monitoring indication indicates at least one of a CORESET or a search space corresponding to the first resource, and where the second resource is based on the at least one of the CORESET or the search space. Additionally, or alternatively, the NE 1400 may be configured to support the early monitoring indication is associated with an orthogonal Zandoff-Chu sequence generated using a cyclic shift, and where the orthogonal Zandoff-Chu sequence is spread based on one or more frequency resources associated with the early monitoring indication.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

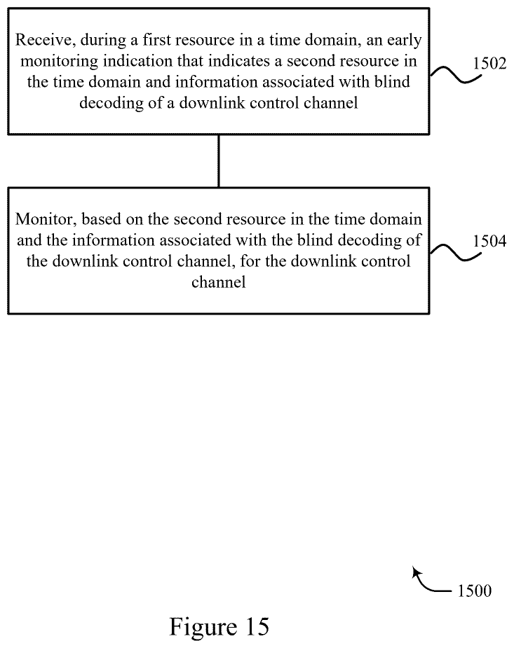

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving, during a first resource in a time domain, an early monitoring indication that indicates a second resource in the time domain and information associated with blind decoding of a downlink control channel. The operations of 1502 may be performed in accordance with examples as described herein. In some implementations, aspects of the operations of 1502 may be performed by a UE as described with reference to FIG. 12.

At 1504, the method may include monitoring, based on the second resource in the time domain and the information associated with the blind decoding of the downlink control channel, for the downlink control channel. The operations of 1504 may be performed in accordance with examples as described herein. In some implementations, aspects of the operations of 1504 may be performed by a UE as described with reference to FIG. 12.

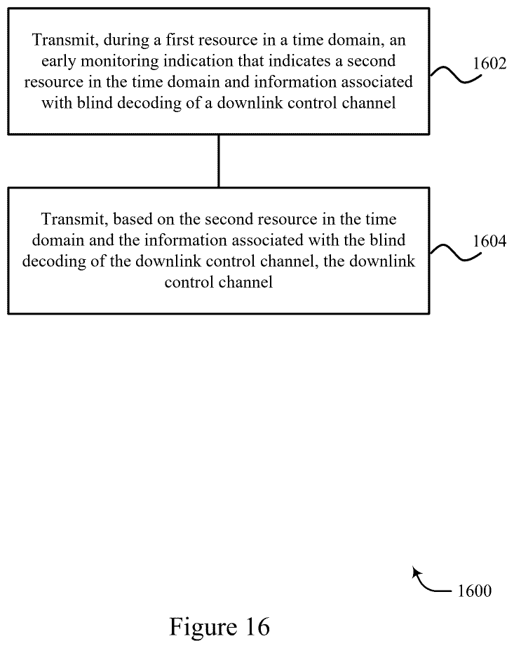

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include transmitting, during a first resource in a time domain, an early monitoring indication that indicates a second resource in the time domain and information associated with blind decoding of a downlink control channel. The operations of 1602 may be performed in accordance with examples as described herein. In some implementations, aspects of the operations of 1602 may be performed by an NE as described with reference to FIG. 14.

At 1604, the method may include transmitting, based on the second resource in the time domain and the information associated with the blind decoding of the downlink control channel, the downlink control channel. The operations of 1604 may be performed in accordance with examples as described herein. In some implementations, aspects of the operations of 1604 may be performed by an NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive, during a first resource in a time domain, an early monitoring indication that indicates a second resource in the time domain and information associated with blind decoding of a downlink control channel; and
monitor, based at least in part on the second resource in the time domain and the information associated with the blind decoding of the downlink control channel, for the downlink control channel.

2. The UE of claim 1, wherein to receive the early monitoring indication, the at least one processor is operable to cause the UE to monitor for the early monitoring indication based at least in part on at least one of a codepoint or a bitmap using a sequence or one or more modulated symbols in one or more resources in the time domain comprising the first resource.

3. The UE of claim 1, wherein the early monitoring indication comprises at least one of a search space to monitor, a search space identifier associated with one or more monitoring occasions, a codepoint associated with search space group switching, or a bitmap associated with the search space group switching.

4. The UE of claim 1, wherein the early monitoring indication comprises at least one of a codepoint or a bitmap that indicates a plurality of consecutive resources in the time domain that comprise the downlink control channel, and wherein the plurality of consecutive resources comprises the second resource.

5. The UE of claim 1, wherein the early monitoring indication comprises at least one of a codepoint or a bitmap that indicates a plurality of non-consecutive resources in the time domain that comprise the downlink control channel, and wherein the at least one processor is operable to cause the UE to monitor, based at least in part on the plurality of non-consecutive resources in the time domain, for the downlink control channel.

6. The UE of claim 1, wherein the early monitoring indication indicates at least one third resource in the time domain without the downlink control channel, and wherein the at least one processor is further operable to cause the UE to refrain from monitoring for the downlink control channel during the at least one third resource.

7. The UE of claim 1, wherein the information comprises at least one of a codepoint or a bitmap that indicates a downlink control information (DCI) format to monitor for the blind decoding of the downlink control channel, a search space identifier, a candidate level to monitor for the blind decoding of the downlink control channel, or an aggregation level to monitor for the blind decoding of the downlink control channel.

8. The UE of claim 1, wherein the UE comprises a first radio and a second radio, and wherein to receive the early monitoring indication, the at least one processor is operable to cause the UE to receive, via the first radio, a wake-up signal for activating the second radio that comprises the early monitoring indication.

9. The UE of claim 1, wherein to receive the early monitoring indication, the at least one processor is operable to cause the UE to receive downlink control information (DCI) comprising the early monitoring indication.

10. The UE of claim 1, wherein the at least one processor is further operable to cause the UE to receive signaling that indicates the first resource.

11. The UE of claim 1, wherein the early monitoring indication is associated with a group of UEs comprising the UE based at least in part on at least one of a sequence of the early monitoring indication or a modulated symbol of the early monitoring indication.

12. The UE of claim 1, wherein the early monitoring indication indicates at least one of a control resource set (CORESET) or a search space corresponding to the first resource, and wherein the second resource is based at least in part on the at least one of the CORESET or the search space.

13. The UE of claim 1, wherein the early monitoring indication is associated with an orthogonal Zandoff-Chu sequence generated using a cyclic shift, and wherein the orthogonal Zandoff-Chu sequence is spread based at least in part on one or more frequency resources associated with the early monitoring indication.

14. A method performed by a user equipment (UE), the method comprising:
receiving, during a first resource in a time domain, an early monitoring indication that indicates a second resource in the time domain and information associated with blind decoding of a downlink control channel; and
monitoring, based at least in part on the second resource in the time domain and the information associated with the blind decoding of the downlink control channel, for the downlink control channel.

15. A network equipment (NE) for wireless communication, comprising:
at least one memory; and
at least one processor coupled with the at least one memory and operable to cause the NE to:
transmit, during a first resource in a time domain, an early monitoring indication that indicates a second resource in the time domain and information associated with blind decoding of a downlink control channel; and
transmit, based at least in part on the second resource in the time domain and the information associated with the blind decoding of the downlink control channel, the downlink control channel.

16. The NE of claim 15, wherein to transmit the early monitoring indication, the at least one processor is operable to cause the NE to transmit the early monitoring indication based at least in part on at least one of a codepoint or a bitmap using a sequence or one or more modulated symbols in one or more resources in the time domain comprising the first resource.

17. The NE of claim 15, wherein the early monitoring indication comprises at least one of a search space to monitor, a search space identifier associated with one or more monitoring occasions, a codepoint associated with search space group switching, or a bitmap associated with the search space group switching.

18. The NE of claim 15, wherein the early monitoring indication comprises at least one of a codepoint or a bitmap that indicates a plurality of consecutive resources in the time domain that comprise the downlink control channel, and wherein the plurality of consecutive resources comprises the second resource.

19. The NE of claim 15, wherein the early monitoring indication comprises at least one of a codepoint or a bitmap that indicates a plurality of non-consecutive resources in the time domain that comprise the downlink control channel, and wherein the at least one processor is operable to cause the NE to transmit, based at least in part on the plurality of non-consecutive resources in the time domain, the downlink control channel.

20. A method performed by a network equipment (NE), the method comprising:
transmitting, during a first resource in a time domain, an early monitoring indication that indicates a second resource in the time domain and information associated with blind decoding of a downlink control channel; and
transmitting, based at least in part on the second resource in the time domain and the information associated with the blind decoding of the downlink control channel, the downlink control channel.
